(19) United States
(12) Patent Application Publication
(10) Pub. No.: US 2019/0215609 A1
(43) Pub. Date: Jul. 11, 2019

(54) EARPHONE WITH NECK BAND

(71) Applicant: JVC KENWOOD CORPORATION, Yokohama-shi (JP)

(72) Inventor: Makoto OURYOUJI, Yokohama-shi (JP)

(21) Appl. No.: 16/240,447

(22) Filed: Jan. 4, 2019

(30) Foreign Application Priority Data
Jan. 11, 2018 (JP) 2018-002601

(51) Int. Cl. H04R 5/033; H04R 1/10

(52) U.S. Cl. CPC H04R 5/0335; H04R 1/105; H04R 1/1008; H04R 2460/17; H04R 1/1016; H04R 1/1066

(57) ABSTRACT

An earphone with a neck band includes a curve-shaped neck band, an earphone portion connected to an end portion of the neck band, and a main body portion provided in a center portion of the neck band and including a circuit board body and a box-shaped housing portion housing the circuit board body. The main body portion includes a low-stiffness portion having lower stiffness than other portions of the main body portion against bending force which increases or decreases a curvature of the neck band.

### CROSS REFERENCE TO RELATED APPLICATION

This application is based upon and claims the benefit of priority from the prior Japanese Patent Application No. 2018-002601 (filing date: Jan. 11, 2018), the entire contents of which are incorporated herein by reference.

### TECHNICAL FIELD

The present invention relates to an earphone with a neck band.

### RELATED ART

An earphone with a neck band which is used with the neck band resting on the head or the neck is known (see Japanese Patent No. 6026235).

The earphone described in Japanese Patent No. 6026235 also includes a receiver configured to wirelessly receive an audio signal and a battery configured to supply power to the receiver.

In a holding band like one described in Japanese Patent No. 6026235, making distal end portions lighter reduces burden on the head or the neck on which the band rests in the used state and is preferable from the viewpoint of fitting. Moreover, the distal ends of the neck band resting on the neck are located near the clavicles of the user and are easily visible to others. Accordingly, the design can be improved if the distal ends can be made slim.

In this regard, in the conventional earphone described in Japanese Patent No. 6026235, the battery and a circuit board assembly including the receiver are provided in a head holder attached to the distal end of the neck band. Accordingly, the distal end portion of the neck band is heavy and wide and the neck band is desired to be improved from the viewpoint of fitting and design.

There is considered a configuration in which the circuit board assembly and the battery are arranged in a center portion of the neck band to be disposed on the head or the back of the neck in the state where the neck band rests on the neck. However, this configuration has a risk of disconnection of wiring patterns on the circuit board and breakage of packaged parts caused by application of force to the circuit board in expansion and deformation of the neck band which occur when the neck band is made to rest on the neck. Thus, it is difficult for the earphone to maintain high reliability.

An object of the present invention is to provide an earphone with a neck band which has high reliability.

### SUMMARY

An earphone with a neck band according to an aspect of the present invention includes a curve-shaped neck band, an earphone portion connected to an end portion of the neck band, and a main body portion provided in a center portion of the neck band and including a circuit board body and a box-shaped housing portion housing the circuit board body. The main body portion includes a low-stiffness portion having lower stiffness than other portions of the main body portion against bending force which increases or decreases a curvature of the neck band.

According to the aspect of the present invention provides an earphone with a neck band which has high reliability.

### BRIEF DESCRIPTION OF THE DRAWINGS

FIG. 1 is a perspective view illustrating an earphone 51 in a used state, the ear phone 51 being Example 1 of an earphone with a neck band according to an embodiment of the present invention;

FIG. 2 is an assembly view of the earphone 51;

FIG. 3 is an assembly view of a main body portion 52a in the earphone 51;

FIG. 4 is a partial cross-sectional view of the main body portion 52a;

FIG. 5 is a cross-sectional view at the position S5-S5 in FIG. 4;

FIG. 6 is a cross-sectional view at the position S6-S6 in FIG. 4;

FIG. 7 is a partial cross-sectional view for explaining an operation of the main body portion 52a;

FIG. 8 is a schematic view of a model of the earphone 51; and

FIG. 9 is a view illustrating a modified example of the main body portion 52a.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

Description will be hereinbelow provided for embodiments of the present invention by referring to the drawings. It should be noted that the same or similar parts and components throughout the drawings will be denoted by the same or similar reference signs, and that descriptions for such parts and components will be omitted or simplified. In addition, it should be noted that the drawings are schematic and therefore different from the actual ones.

An earphone with a neck band according to an embodiment of the present invention is described by using an earphone 51.

### Example

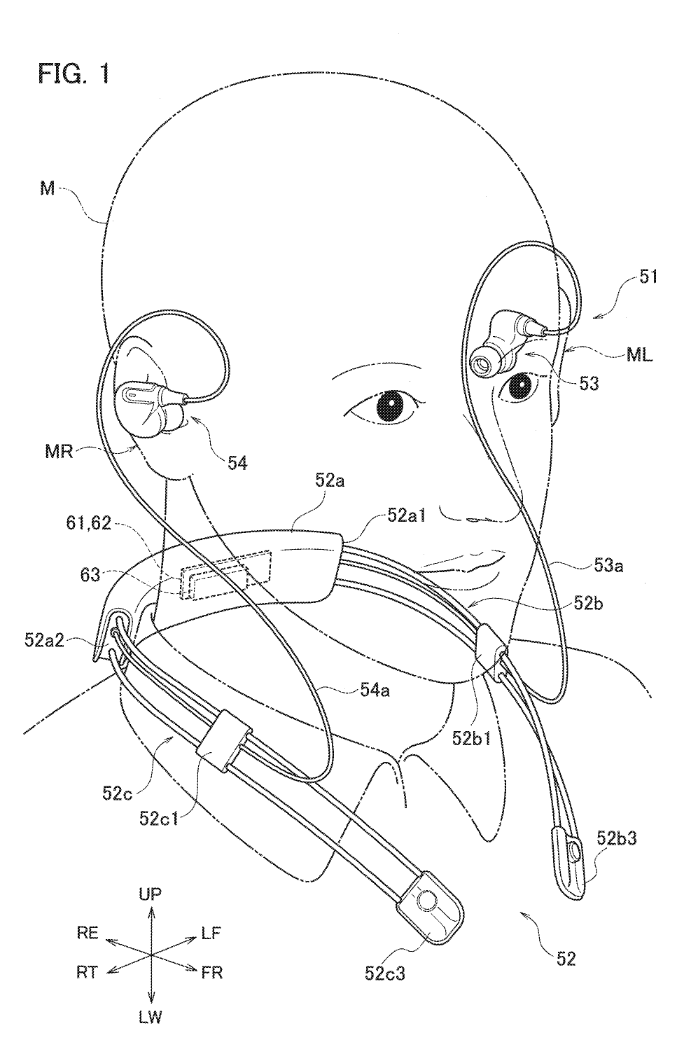

FIG. 1 is a perspective view illustrating an example of a state where the earphone 51 is used by a user M. Directions of up UP, down LW, left LF, right RT, front FR, and rear RE in the state where the user M wears the earphone 51 are specified as illustrated by the arrows in FIG. 1 for the sake of description. Specifically, the direction toward the top of the head of the user M is up, the direction in which the face is facing is front, and the left-hand side is left.

The earphone 51 includes a curve-shaped neck band 52 having a substantially C shape in a plan view, a left earphone portion 53 configured to be fitted into the left ear of the user, and a right earphone portion 54 configured to be fitted into the right ear. The left earphone portion 53 and the right earphone portion 54 are connected respectively to distal ends of a cable 53a and a cable 54a which extend from the neck band 52.

When the earphone 51 is used, the user M expands the distal end side of neck band 52 to put the neck band 52 on the neck or the back of the head from the rear side and inserts the left earphone portion 53 and the right earphone portion 54 into the left ear ML and the right ear MR, respectively.

When the neck band 52 deformed to be expanded on the distal end side is putted on the back of the head, the neck band 52 presses the side surfaces of the head with appropriate force in a pinching manner by means of elastic resilience. When the neck band 52 rests on the neck, the shape thereof returns to an original shape after passing the neck.

The neck band 52 includes a main body portion 52a, a left arm portion 52b, and a right arm portion 52c.

The main body portion 52a is located at the center of the substantially C-shape. One end of the left arm portion 52b is connected to a left end portion 52a1 of the main body portion 52a. The left arm portion 52b is formed such that, when the left arm portion 52b rests on the neck, the other end which is the distal end extends along the left side of the neck to a position near the clavicle.

One end of the right arm portion 52c is connected to a right end portion 52a2 of the main body portion 52a. The right arm portion 52c is formed such that, when the right arm portion 52c rests on the neck, the other end which is the distal end extends along the right side of the neck to a position near the clavicle.

The cable 53a and the cable 54a are lead out from the left end portion 52a1 and the right end portion 52a2 of the main body portion 52a, respectively. Moreover, the cable 53a and the cable 54a are connected to the left earphone portion 53 and the right earphone portion 54 via a clamper 52b1 and a clamper 52c1 attached to the left arm portion 52b and the right arm portion 52c.

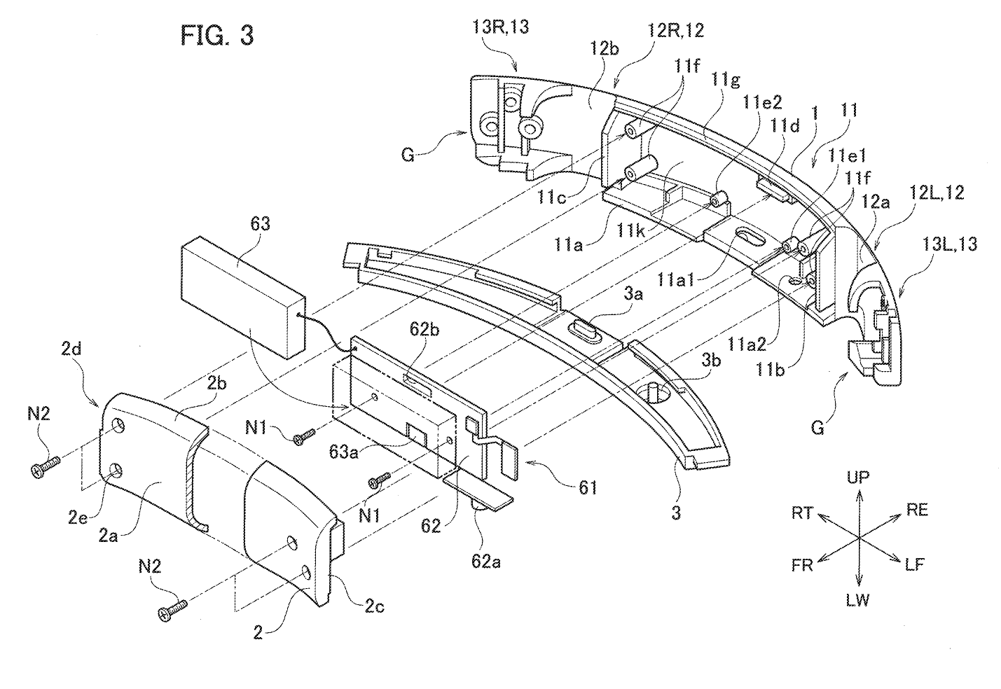

A circuit board body 62 and a battery 63 are housed in the main body portion 52a. The circuit board body 62 includes a receiver 61 (see FIG. 3) configured to wirelessly receive an audio signal and a driver (not illustrated) configured to output the audio signal received by the receiver 61 as audio from the left earphone portion 53 and the right earphone portion 54. The battery 63 supplies power to the circuit board body 62.

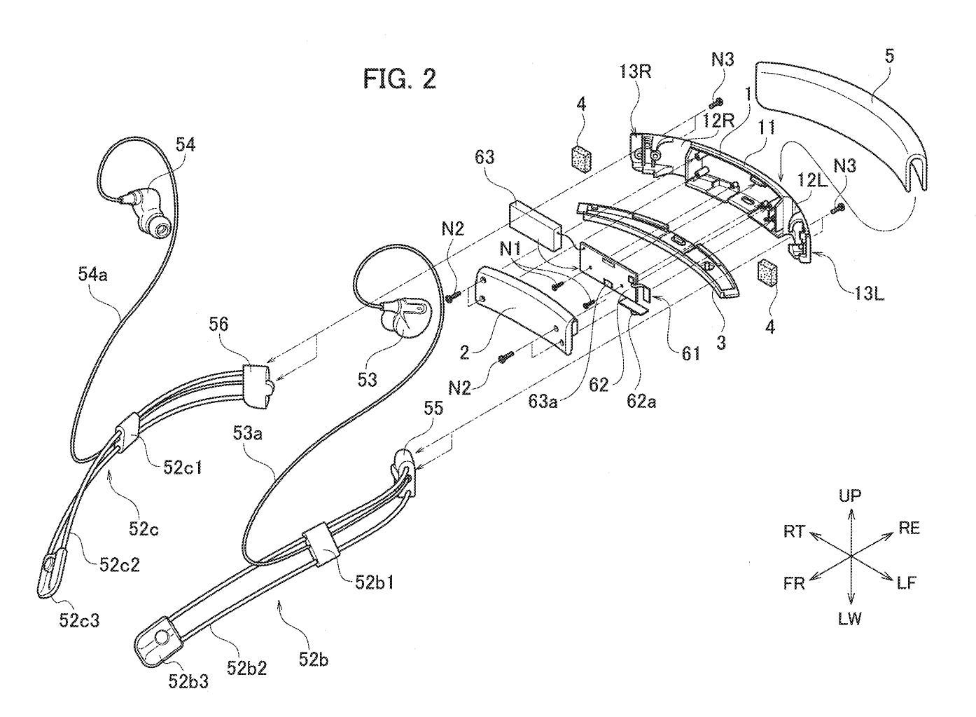

A power button 62a (see FIG. 3) which is used to turn on and off the power and a terminal 63a (see FIGS. 2 and 3) to which a charging cable is connected in charging of the battery 63 are provided on a lower surface of the main body portion 52a.

The earphone 51 wirelessly receives the audio signal from the outside and outputs the audio based on the received audio signal from the left earphone portion 53 and the right earphone portion 54 by using the aforementioned configuration.

FIG. 2 is an assembly view of the earphone 51. For the sake of convenience, directions substantially corresponding to the directions of front FR, rear RE, up UP, down LW, left LF, and right RT in FIG. 1 are specified by using arrows. The main body portion 52a includes a base 1 which is a strip-shaped member curved in a longitudinal direction, a lid 2 which is attached to a center portion of the base 1 in the left-right direction, and a bottom cover 3 which is attached to cover a lower side of the base 1.

The base 1 and the lid 2 are made of resin and the bottom cover 3 is made of rubber. Examples of the resin include polycarbonate (PC) and acrylonitrile butadiene styrene (ABS) and examples of the rubber include silicone rubber.

An arm attachment portion 13L, which is a portion for attaching the left arm portion 52b by using a self-tapping screw N3 is provided in a left end portion of the base 1.

An arm attachment portion 13R which is a portion for attaching the right arm portion 52c by using the self-tapping screw N3 is provided in a right end portion of the base 1.

The arm portions 52b, 52c are formed of iron wires 52b2, 52c2, arm holders 55, 56, and resin covers 52b3, 52c3. In the left arm portion 52b (right arm portion 52c), the iron wire 52b2 (52c2) is formed in a narrow U-shape by being folded back. A folded back portion of the iron wire 52b2 (52c2) is covered with the resin cover 52b3 (52c3) as a distal end portion. Moreover, a pair of end portions of the iron wire 52b2 (52c2) are covered with the left arm holder 55 (right arm holder 56) as a base portion and are formed to be integral.

Furthermore, the left arm holder 55 (right arm holder 56) is attached to the arm attachment portion 13L (13R) of the base 1 by using the self-tapping screw N3 (N3) and the left arm portion 52b (right arm portion 52c) is thereby formed to be integral with the main body portion 52a.

Moreover, in this attachment, the bottom cover 3 is fixed to the base 1 by being fastened together with the arm holders 55, 56 by using the self-tapping screws N3.

The bending stiffness of the material of the wires 52b2, 52c2 is set to be so high that the left arm portion 52b and the right area portion 52c hardly deform in the distal end expanding deformation which occurs when the user puts the neck band 52 on or off the head or the neck.

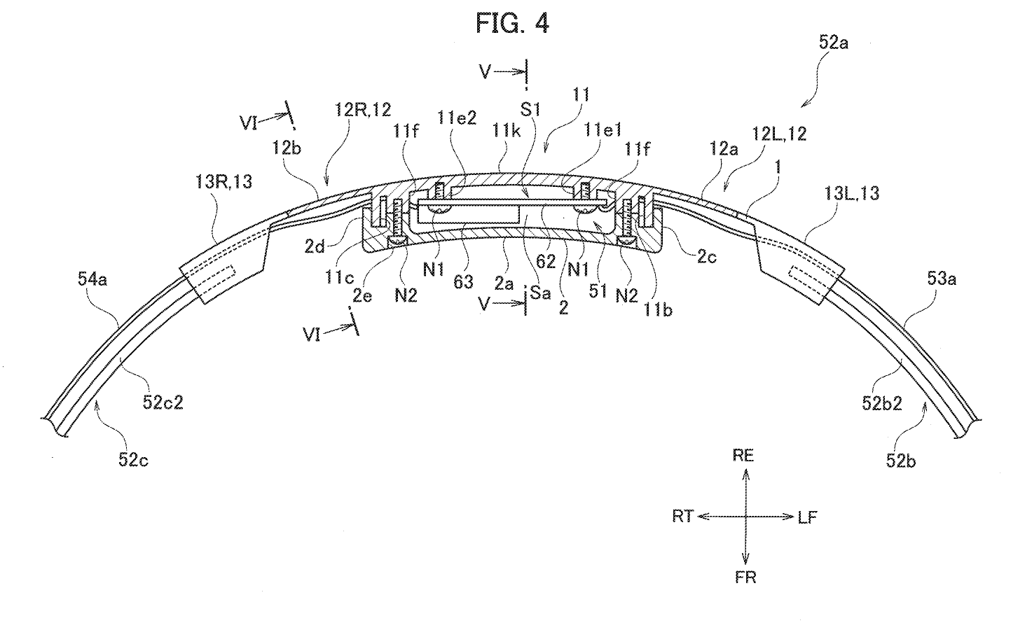

Next, assembly steps of the main body portion 52a are described with reference to FIGS. 2 to 4. The order of executing the assembly of the main body portion 52a described below and the attachment of the left arm portion 52b and the right arm portion. 52c described above is not limited to a certain order. FIG. 3 is an enlarged assembly view illustrating some parts extracted from the parts of the main body portion 52a. FIG. 4 is a horizontal cross-sectional view of a portion including the main body portion 52a and part of the left arm portion 52b and the right arm portion 52c.

The battery 63 and the circuit board body 62 are supplied in advance from a previous step in a developed state (see FIGS. 2 and 3 (solid lines)). First, the circuit board body 62 is fixed to the base 1 by screwing self-tapping screws N1 to bosses 11e1, 11e2 with prepared holes (FIGS. 3 and 4). In this case, a rib 11d with a step in the base 1 engages with an engagement hole 62b in the circuit board body 62 and the circuit board body 62 is aligned relative to the base 1.

Next, the battery 63 is laid on the circuit board body 62 to be set to a mode illustrated in FIG. 4. Then, the lid 2 is fixed to the base 1 by using screws. Specifically, self-tapping screws N2 are inserted into screw holes 2e (four portions) in the lid 2 and are screwed to bosses 11f with prepared holes in the base 1 to fix the lid 2. Attaching the lid 2 causes the lid 2 and the base 1 to form a housing portion S1 having a space Va in which the circuit board body 62 and the battery 63 can be housed.

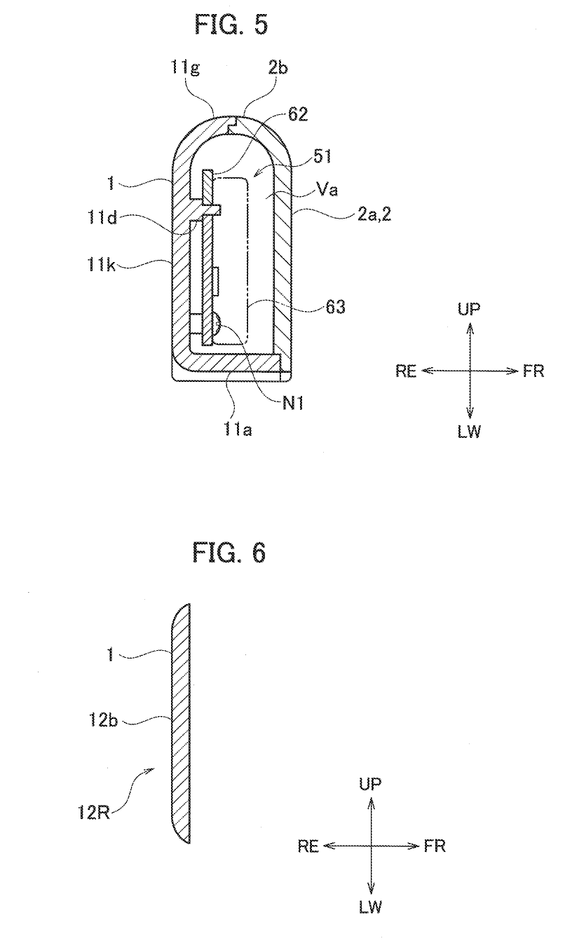

The housing portion S1 is described with reference to also FIG. 5 which is a schematic cross-sectional view at the position S5-S5 in FIG. 4. In the base 1, an upper wall 11g protruding and curving forward, a plate-shaped left rib 11b extending forward, a plate-shaped right rib 11c extending forward, and a plate-shape bottom wall 11a protruding forward are formed as an upper end, a left end, a right end, and a lower end, respectively, in a portion where the lid 2 is to be attached.

Moreover, a left wall 2c and a right wall 2d are formed at the left end and the right end of the lid 2, respectively (FIGS. 3 and 4).

The lid 2 is attached to the base 1 such that the upper and lower portions of the lid 2 abut respectively on the upper wall 11g and the bottom wall 11a of the base 1, the left wall 2c is arranged adjacent to and outside of the left rib 11b, and the right wall 2d is arranged adjacent to and outside of the right rib 11c. In other words, the lid 2 is attached in left and right ends with the walls of the lid 2 substantially engaging with outer sides of the ribs of the base 1. As described above, the housing portion S1 is formed in a box shape with high stiffness in which the upper, lower, left, and right sides of the housing portion S1 are surrounded by wall members, and the circuit board body 62 and the battery 63 are housed in the housing portion S1.

In the base 1, a connection portion 12L is formed between the housing portion S1 and the arm attachment portion 13L and a connection portion 12R is formed between the housing portion S1 and the arm attachment portion 13R. Specifically, portions referred to as the connection portions 12L, 12R in the base 1 are curved plate portions 12a, 12b with no protrusions. In this example, the curved plate portions 12a, 12b have rear surfaces continuous with other portions as part of an arc-shaped curved rear surface of the base 1.

Accordingly, rectangular solid cushions 4 are attached to front surfaces of the curved plate portions 12a, 12b for height alignment with the lid 2 of the housing portion S1 on the front side (see FIG. 2). The cushions 4 are soft sponges and are not members which affect the bending stiffness of the main body portion 52a. In other words, the cushions 4 are members whose effects on the bending stiffness of the main body portion 52a do not have to be considered. An exterior cover 5 with a narrow U-shape is fitted from above to an assembly formed by attaching the lid 2, the pair of cushions 4, the right arm holder 56, and the left arm holder 55 to the base 1 and the assembly of the main body portion 52a is thereby completed.

The exterior cover 5 is made of flexible resin material. The exterior cover 5 improves the exterior quality and provides soft touch to the neck when the earphone 51 is worn.

Next, the bending stiffness of the main body portion 52a is described with reference to FIGS. 3 and 4. As illustrated in FIG. 3, the base 1 of the main body portion 52a includes the arm attachment portions 13L, 13R in the left and right end portions and includes the housing portion S1 in the center portion. In the base 1, the connection portion 12L is formed between the housing portion S1 and the arm attachment portion 13L and the connection portion 12R is fainted between the housing portion S1 and the arm attachment portion 13R.

The housing portion S1 is a portion with high bending stiffness as described above. In the arm attachment portion 13L and the arm attachment portion 13R, boss-rib groups G (see FIG. 3) in which bosses for attaching the left arm holder 55 and the right arm holder 56 and ribs for providing strength are arranged in a concentrated manner are formed, and the arm attachment portion 13L and the arm attachment portion 13R are thus made to have high stiffness against bending.

Accordingly, the housing portion S1, the arm attachment portion 13L, and the arm attachment portion 13R in the base 1 are less deformable to at least bending force which changes the curvature of the base 1 (deformation in which the C-shape in the earphone 51 is expanded and closed by moving the distal ends of the left arm portion 52b and the right arm portion 52c of the earphone 51 away from and close to each other).

In contrast to these portions with high stiffness, the portions corresponding to the connection portions 12L, 12R in the base I are curved plate portions 12a, 12b without protrusions. A cross-sectional shape of the curved plate portion 12b is illustrated as a representative in FIG. 6 which is a cross-sectional at the position S6-S6 in FIG. 4.

Since the curved plate portions 12a, 12b extend in the curved-plate shapes in a direction substantially orthogonal to a direction of bending in which the curvature of the base 1 is changed, the curved plate portions 12a, 12b have low bending stiffness and deforms far more easily than the housing portion S1, the arm attachment portion 13L, and the arm attachment portion 13R.

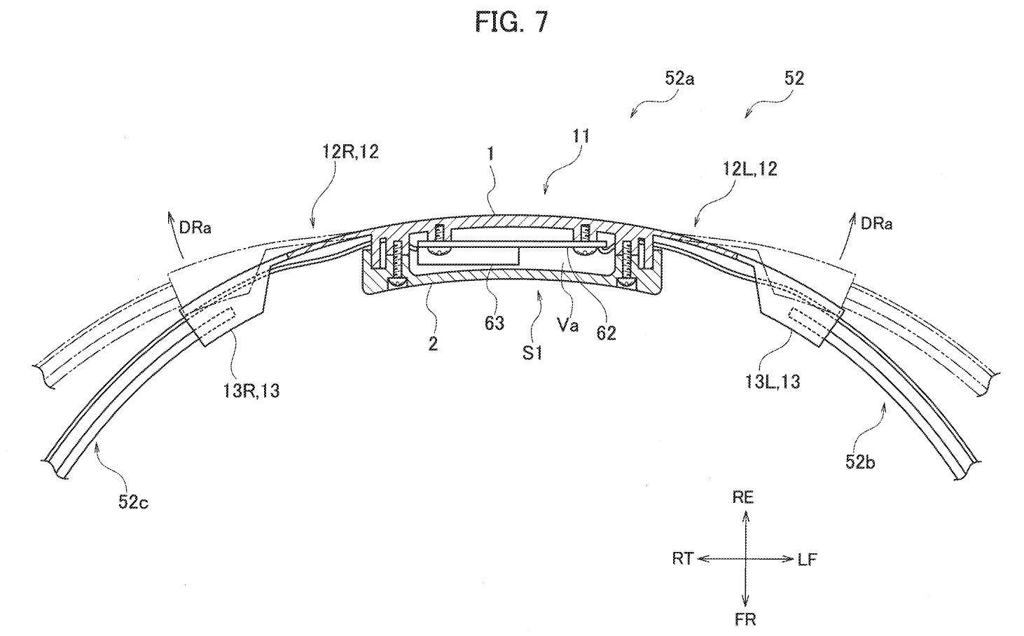

Accordingly, as illustrated in FIG. 7, when the left arm portion 52b and the right arm portion 52c are expanded (arrow DRa), the arm attachment portions 13L, 13R and the housing portion S1 hardly deform and only the connection portions 12L, 12R formed of the curved plate portions 12a, 12b substantially deform by being bent.

Thus, no force is applied to the circuit board body 62 and the battery 63 housed in the housing portion S1 when the neck band 52 of the earphone 51 is deformed to be put on or off the neck. Hence, the earphone 51 can have high reliability.

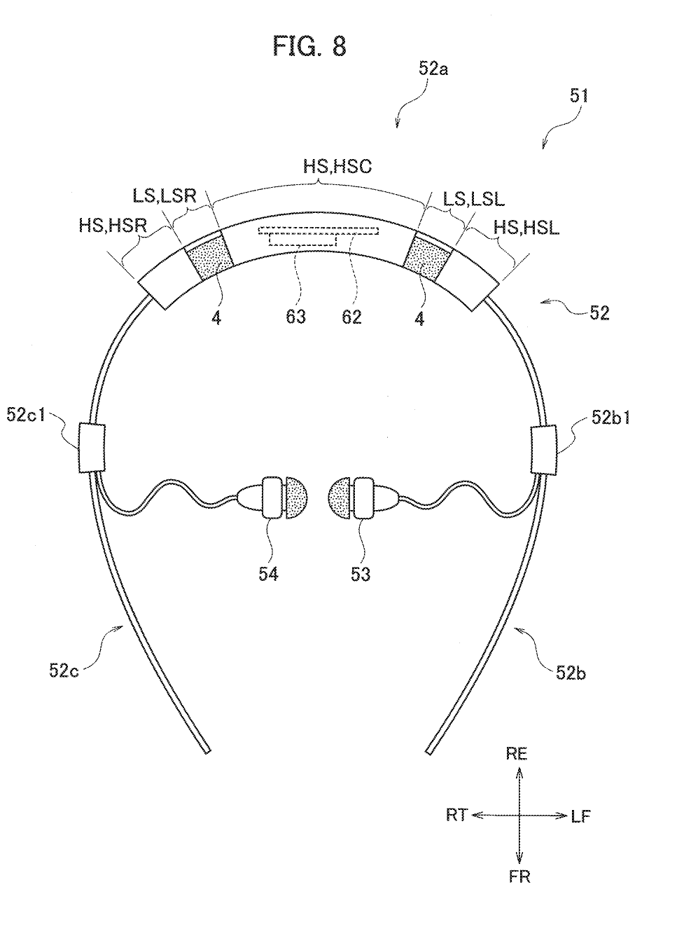

A model of the configuration of the earphone 51 is described with reference to FIG. 8. As illustrated in FIG. 8, the main body portion 52a of the earphone 51 is disposed at a center position of the neck band 52. The earphone 51 includes multiple (three in this example) high-stiffness portions HSL, HSC, HSR as high-stiffness portions HS having high stiffness against bending which increases and decreases the curvature, the high-stiffness portions HSL, HSC, HSR spaced away from one another in the direction in which the main body portion 52a extends. The high-stiffness portions HSL, HSC, HSR are the arm attachment portion 13L, the housing portion S1, and the arm attachment portion 13R, respectively.

Moreover, the main body portion 52a includes two low-stiffness portions LSL, LSR between the adjacent high-stiffness portions HS as low-stiffness portions LS having stiffness so low that the low-stiffness portions LS easily deform when the neck band 52 is expanded such that the distal ends of the left arm portion 52b and the right arm portion 52c are moved away from each other. The low-stiffness portions LSL, LSR are the connection portions 12L, 12R, respectively.

Due to this configuration, as illustrated in FIG. 7, when the neck band 52 of the earphone 51 is expanded to be put on the neck, the left arm portion 52b and the right arm portion 52c do not deform and, in the main body portion 52a, only the low-stiffness portions LS deform and the high-stiffness portions HS substantially do not deform.

Accordingly, no force due to bending is applied to the circuit board body 62 and the battery 63 housed in the housing portion S1 formed as the high-stiffness portion HS. Thus, there is no risk of disconnection in the wiring pattern on the circuit board and breakage of packaged parts and the earphone 51 can have high reliability.

The example described above in detail is not limited to the aforementioned configuration and may be modified as modified examples within a scope not departing from the spirit of the present invention.

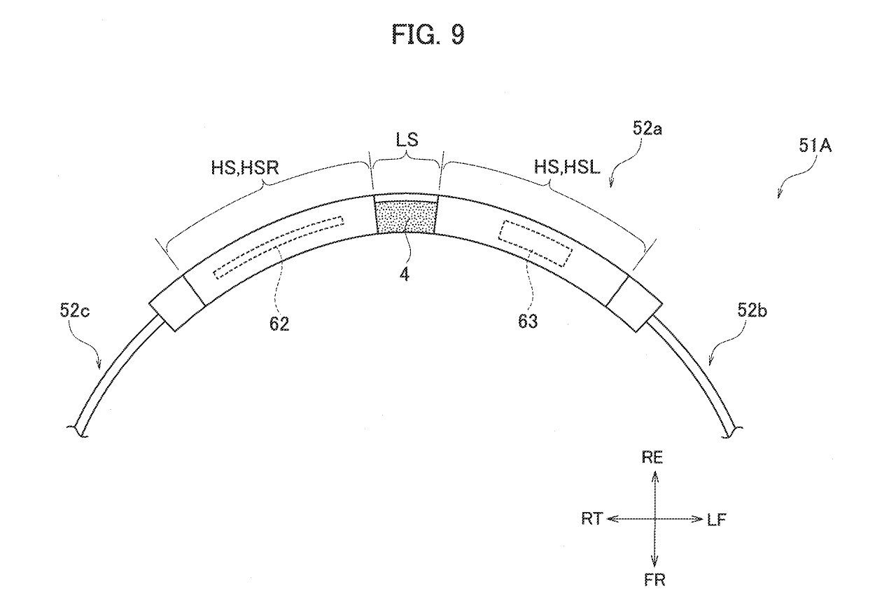

The arrangement of the high-stiffness portions HS and the low-stiffness portions LS in the main body portion 52a is not limited to the configuration described with reference to FIG. 8 and may be changed as necessary. For example, as illustrated in FIG. 9, the configuration may be such that the low-stiffness portion LS is arranged in the center portion of the main body portion 52a and the high-stiffness portions HS (HSL, HSR) are arranged on left and right sides of the low-stiffness portion LS. In this case, the configuration may be such that the high-stiffness portions HSL, HSR have box structures similar to that of the aforementioned housing portion S1 and the circuit board body 62 is housed in one of the box structures while the battery 63 is housed in the other box structure. This can reduce (or eliminate) weight unevenness in the left-right direction which occurs when the circuit board body 62 and the battery 63 are housed in one of the box structures.

In the example and the modified example, the low-stiffness portions LS are portions which are made more deformable than the high-stiffness portions HS by forming the base 1 in the curved-plate shape without protrusions such as ribs and thereby reducing the second moment of area against the bending force. In other words, the low-stiffness portions LS do not have to be formed in the shape without protrusions as long as it has a shape with a smaller second moment of area than that in the high-stiffness portions HS, and may have protrusions such as ribs.

The housing portion S1 is not limited to the portion in which the lid 2 is attached from the inner side and the lid 2 may be attached from another direction to improve the stiffness. The neck band 52 is not limited to a band applied by being put on the neck and may be a holding band which has a shape matching the back of the head or the top of the head to rest on the head.

The earphone 51 is not limited to one including two earphone portions (left earphone portion 53 and right earphone portion 54) and may be one including only one earphone portion.

What is claimed is:

1. An earphone with a neck band comprising:
a curve-shaped neck band;
an earphone portion connected to an end portion of the neck band; and
a main body portion provided in a center portion of the neck band and including a circuit board body and a box-shaped housing portion housing the circuit board body, wherein
the main body portion includes a low-stiffness portion having lower stiffness than other portions of the main body portion against bending force which increases or decreases a curvature of the neck band.

2. The earphone with a neck band according to claim 1, comprising:
a pair of the low-stiffness portions on either side of the housing portion.

3. The earphone with a neck band according to claim 1, wherein
the main body portion includes a curve-shaped base, and
the housing portion is formed by a portion of the base and a lid configured to be attached to the portion of the base and form a housing space configured to house the circuit board body between the lid and the portion of the base.

4. The earphone with a neck band according to claim 3, wherein the low-stiffness portion is formed as a curved plate-shaped portion of the base.
